(19) United States
(12) Patent Application Publication
(10) Pub. No.: US 2025/0326148 A1
(43) Pub. Date: Oct. 23, 2025

(54) SYSTEM AND METHOD FOR PROVIDING A CUTTING MEMBER

(71) Applicant: Slice, Inc., Sunny Isles, FL (US)

(72) Inventor: Robert Joseph Gallegos, Fremont, CA (US)

(21) Appl. No.: 18/964,653

(22) Filed: Dec. 1, 2024

Related U.S. Application Data
(63) Continuation of application No. 17/498,362, filed on Oct. 11, 2021, now abandoned.

(51) Int. Cl. B26D 1/00; B24B 3/36; B26B 9/02; G01N 3/58

(52) U.S. Cl. CPC B26D 1/0006; B24B 3/36; G01N 3/58; B26B 9/02; B26D 2001/0053; B26D 2001/006

(57) ABSTRACT

A method is disclosed. The method includes providing a ceramic blade having a thickness and a ceramic cutting edge portion, providing a primary grind having a primary angle to the ceramic cutting edge portion based on a predetermined primary ratio, and providing a micro grind having a micro angle to the ceramic cutting edge portion based on a predetermined micro ratio. The predetermined primary ratio is a predetermined thickness divided by a predetermined primary angle. The predetermined micro ratio is the predetermined thickness divided by a predetermined micro angle. The method includes measuring at least one of the thickness, the primary angle, and the micro angle, and comparing at least one of the measured thickness to the predetermined thickness, the measured primary angle to the predetermined primary angle, and the measured micro angle to the predetermined micro angle.

### CROSS-REFERENCE TO RELATED APPLICATIONS

The present application is a continuation of U.S. application Ser. No. 17/498,362, entitled “System and Method for Providing a Cutting Member”, filed on Oct. 11, 2021, the entire disclosure of which is hereby incorporated by reference herein.

### TECHNICAL FIELD

The present disclosure generally relates to a system and method for providing a member, and more particularly to a system and method for providing a cutting member.

### BACKGROUND

Cutting tools designed for various uses have been produced from the beginning of the iron age. The overriding objective for conventional sharpening of a cutting edge is to create an edge that is as sharp as possible. This objective seeks to extend the time between sharpening processes, and to maximize cutting performance while minimizing cutting effort. However, conventional methods involve an inverse relationship regarding sharpening, in which the sharper a blade becomes, the quicker that blade will dull. Such conventional methods are typically used on metal blades, as well as other blade materials such as ceramic blades.

The desire to optimize blade sharpness is universal to the cutting device industry as well as hobbyists and cutting tool enthusiasts. Users and enthusiasts often resharpen or further sharpen new factory-sharpened blade edges. Many techniques regarding blade profiles and sharpening are employed as after-market enhancements.

The micro-grind of traditional metal and ceramic blades is intended to remove microscopic burrs and rolled edges, which are artifacts of sharpening processes produced by using grinding stones, wheels and other apparatuses. Stropping and other techniques are often used to remove these artifacts, which produce an even sharper cutting edge while also removing irregularities such as micro chipping that also affects a blade's sharpness and longevity.

Conventional techniques typically maximize the usage of a blade between sharpening processes by making the blade edge as sharp as possible. This results in blade edges that are so sharp that the blades create a safety hazard beginning with initial use of the blade. The conventional blades then dull relatively quickly, creating another safety hazard because the blade becomes so dull that the force involved in cutting with the blade increases, often leading to dull blade type injuries. Accordingly, safety hazards associated with conventionally sharpened blades typically present dangerous conditions at both a beginning and an end of a sharpening cycle.

The exemplary disclosed system and method are directed to overcoming one or more of the shortcomings set forth above and/or other deficiencies in existing technology.

### SUMMARY OF THE DISCLOSURE

In one exemplary aspect, the present disclosure is directed to a method. The method includes providing a ceramic blade having a thickness and a ceramic cutting edge portion, providing a primary grind having a primary angle to the ceramic cutting edge portion based on a predetermined primary ratio, and providing a micro grind having a micro angle to the ceramic cutting edge portion based on a predetermined micro ratio. The predetermined primary ratio is a predetermined thickness divided by a predetermined primary angle. The predetermined micro ratio is the predetermined thickness divided by a predetermined micro angle. The method includes measuring at least one of the thickness, the primary angle, and the micro angle, and comparing at least one of the measured thickness to the predetermined thickness, the measured primary angle to the predetermined primary angle, and the measured micro angle to the predetermined micro angle.

In another aspect, the present disclosure is directed to a method. The method includes providing a ceramic blade having a thickness and a ceramic cutting edge portion, providing a primary grind having a primary angle to the ceramic cutting edge portion based on a predetermined primary ratio, and providing a micro grind having a micro angle to the ceramic cutting edge portion based on a predetermined micro ratio. The predetermined primary ratio is a predetermined thickness divided by a predetermined primary angle. The predetermined micro ratio is the predetermined thickness divided by a predetermined micro angle. The method includes measuring a sharpness of the ceramic cutting edge portion and comparing the sharpness of the ceramic cutting edge portion to a predetermined sharpness that is based on the predetermined primary ratio and the predetermined micro ratio.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still be within the spirit of the disclosure as described herein.

FIG. 1 illustrates a front view of at least some exemplary embodiments of the present disclosure;

FIG. 2 illustrates a perspective view of at least some exemplary embodiments of the present disclosure;

FIG. 3 illustrates a front view of at least some exemplary embodiments of the present disclosure;

FIG. 4 illustrates a schematic view of at least some exemplary embodiments of the present disclosure;

FIG. 5 illustrates an exemplary process of at least some exemplary embodiments of the present disclosure;

FIG. 6 illustrates an exemplary table describing at least some exemplary embodiments of the present disclosure;

FIG. 7 is a schematic illustration of an exemplary computing device, in accordance with at least some exemplary embodiments of the present disclosure; and

FIG. 8 is a schematic illustration of an exemplary network, in accordance with at least some exemplary embodiments of the present disclosure.

### DETAILED DESCRIPTION AND INDUSTRIAL APPLICABILITY

The exemplary disclosed system and method may be a system and method for providing a cutting member. For example, the exemplary disclosed system and method may be a system and method for manufacturing a blade. In at least some exemplary embodiments, the exemplary disclosed system and method may be a system and method that may be used for quality control during manufacture of a blade. The exemplary disclosed system and method may be a system and method that may be used for measuring and/or controlling a sharpness of a manufactured blade.

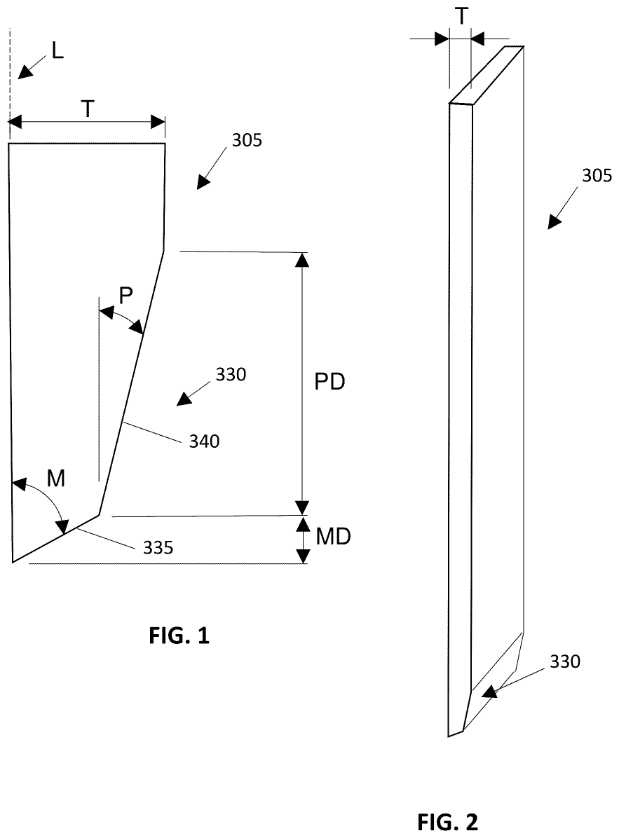

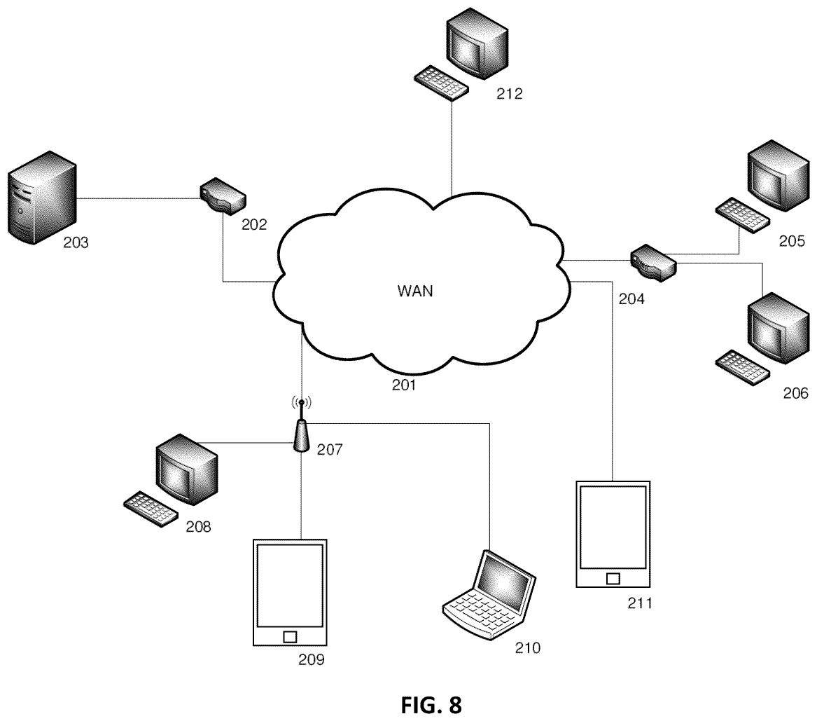

As illustrated in FIGS. 1, 2, and 4, a system 300 may include a cutting member 305, a sensing assembly 310, a testing assembly 315, a network 320, and one or more user devices 325. Sensing assembly 310 may sense properties (e.g., characteristics or parameters) of cutting member 305. Testing assembly 315 may test properties (e.g., characteristics or parameters) of cutting member 305. Network 320 and/or one or more user devices 325 may be in communication with sensing assembly 310 and testing assembly 315. Sensing assembly 310 and testing assembly 315 may communicate with network 320 and with one or more user devices 325 either directly or via network 320 using any suitable communication technique for example as described herein. Network 320 may be any suitable network such as the exemplary disclosed network described below regarding FIG. 8.

Cutting member 305 may be a blade or any other suitable cutting member. Cutting member 305 may be any suitable blade or cutter for cutting of a material. Cutting member 305 may be a removable blade that may be removably received in a blade cartridge (e.g., or a fixed blade) of a cutting device, a knife blade, a scraper blade, a ripper blade, or any other suitable blade of a cutting device.

Cutting member 305 may be formed from any suitable material for a blade, cutter, or other suitable cutting member for cutting a material of an object (e.g., object 308). For example, cutting member 305 may be formed from any suitable material that is capable of withstanding extended use before becoming dull or unusable. Cutting member 305 may be formed from material having a hardness that may be greater than a hardness of metal material (e.g., harder than a hardness of steel) and that may be less than a hardness of diamond. Cutting member 305 may be formed from ceramic material or any other suitable material having a hardness similar to a hardness of ceramic material. Cutting member 305 may be formed from ceramic materials such as Zirconium Oxide or any other suitable ceramic materials for use in a blade. Cutting member 305 may include rounded tips and/or have any other suitable shape or configuration for reducing the chance of a user being cut unintentionally by cutting member 305.

The exemplary disclosed materials and hardness properties of cutting member 305 set forth above may allow for cutting member 305 to be provided with a relatively low sharpness (e.g., less sharp than metal blades). For example as described herein, because the exemplary materials of cutting member 305 disclosed above (e.g., ceramic materials) may be harder than materials such as metal (e.g., may be many times harder than materials such as steel), cutting member 305 may be provided with relatively less sharpness than a comparable metal blade while still performing cutting tasks at a similar level as the sharper comparable blade by virtue of the relatively greater hardness of cutting member 305.

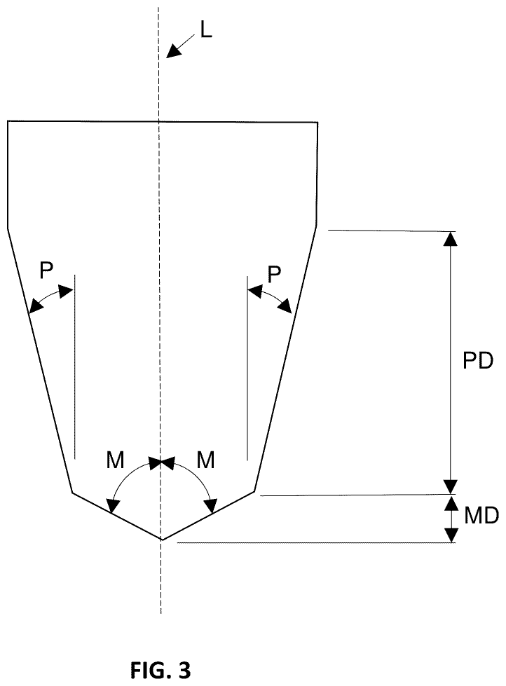

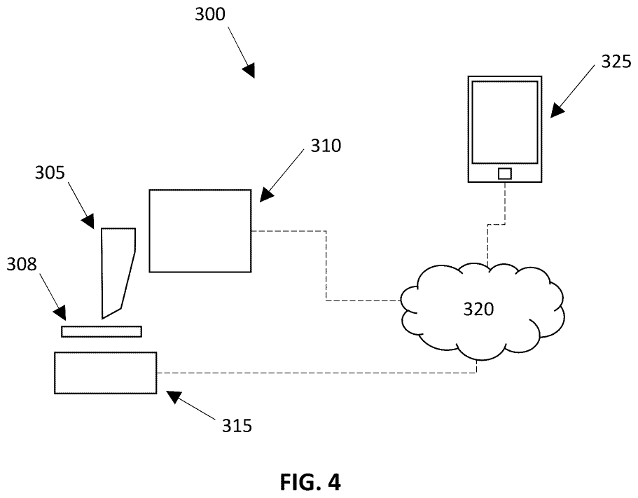

As illustrated in FIGS. 1 and 2, cutting member 305 may include a cutting edge portion 330. Cutting edge portion 330 may include a primary edge portion PD and a micro edge portion MD. Micro edge portion MD may include a micro grind including a micro edge 335 that may be angled at a micro angle M relative to a longitudinal axis L (e.g., or an axis parallel to longitudinal axis L). Primary edge portion PD may include a primary grind including a primary edge 340 that may be angled at a primary angle P relative to longitudinal axis L (e.g., or an axis parallel to longitudinal axis L). Primary edge portion PD and micro edge portion MD may form a double grind that may provide a relatively shortened cutting zone. For example, micro edge portion MD may form an initial cutting zone that may be relatively shorter and less sharp than comparable blades that do not include a double grind. Cutting member 305 may also have a thickness T. Cutting member 305 may be a single-edged blade as illustrated in FIGS. 1 and 2 or a double-edged blade having portions that may be disposed symmetrically about longitudinal axis L for example as illustrated in FIG. 3.

User device 325 may be any suitable user device for receiving input and/or providing output (e.g., raw data or other desired information) to a user. User device 325 may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300 (e.g., sensing assembly 310 and/or testing assembly 315), and/or any other suitable user device or interface. For example, user device 325 may include a touchscreen device of a smartphone or handheld tablet. For example, user device 325 may include a display that may include a graphical user interface to facilitate entry of input by a user and/or receiving output. For example, system 300 may provide notifications to a user via output transmitted to user device 325. User device 325 may communicate with components of sensing assembly 310 and/or testing assembly 315 by any suitable technique such as, for example, as described below.

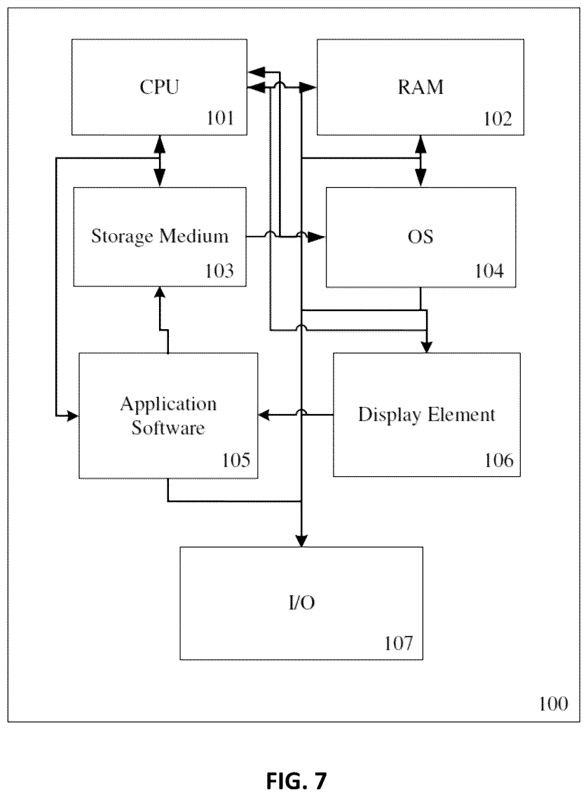

A controller for controlling an operation of components of system 300 may be integrated into any suitable component of system 300 (e.g., user device 325 and/or network 320) and may control an operation of the exemplary disclosed components of system 300 (e.g., sensing assembly 310 and/or testing assembly 315). The controller may include for example a processor (e.g., micro-processing logic control device) or board components (e.g., and/or components similar to as described below regarding FIG. 7). Also for example, the controller may include input/output arrangements that allow it to be connected (e.g., via wireless, Wi-Fi, Bluetooth, or any other suitable communication technique) to other components of system 300. For example, the controller may control an operation of sensing assembly 310 and/or testing assembly 315 based on input received from an exemplary disclosed module of system 300 (e.g., as described below), user device 325, and/or input provided directly to sensing assembly 310 and/or testing assembly 315 via any suitable user interface such as a switch, keypad, button, and/or a touchscreen for example as described below. The controller may communicate with components of system 300 via wireless communication, Wi-Fi, Bluetooth, network communication, internet, and/or any other suitable technique (e.g., as disclosed herein).

System 300 may include one or more modules that may be partially or substantially entirely integrated with one or more components of system 300 such as, for example, network 320, user device 325, and/or the exemplary disclosed controller. The one or more modules may be software modules as described for example below regarding FIG. 7. For example, the one or more modules may include computer-executable code stored in non-volatile memory. The one or more modules (e.g., a module for Bluetooth communication, a module for Wi-Fi communication, a module for executing the exemplary disclosed algorithms, and/or any other suitable module) may store data and/or be used to control some or all of the exemplary disclosed processes described herein. The one or more modules may be used in conjunction with an application programming interface (API) or other suitable interface for example as described herein (e.g., operated using user device 325).

Sensing assembly 310 may include any suitable sensor or sensors for sensing any desired properties (e.g., characteristics or parameters) of cutting member 305. For example, sensing assembly 310 may be any suitable sensor assembly for measuring primary angle P, micro angle M, and/or thickness T of cutting member 305. Sensing assembly 310 may include one or more optical measuring devices such as an optimeter or an optical comparator. Sensing assembly 310 may include an optical lever and/or a mechanical-optical comparator. Sensing assembly 310 may include a coordinate measuring machine (e.g., a digital coordinate measuring machine) including any suitable probe such as, for example, a laser probe, an optical probe, a mechanical probe, and/or a white light probe. Sensing assembly 310 may include any suitable communication components for transferring data to and communicating with network 320, user device 325, and/or any other suitable component of system 300 for example via the exemplary disclosed communication techniques described herein. The exemplary disclosed controller and module may process and perform calculations using the sensed data to determine any suitable properties of cutting member 305 such as, for example, calculating primary angle P, micro angle M, and/or thickness T (e.g., or these properties may be directly determined by sensing assembly 310 and provided to the exemplary disclosed controller and module as sensed data).

Testing assembly 315 may be any suitable testing assembly for determining any desired properties (e.g., characteristics or parameters) of cutting member 305. Testing assembly 315 may include any suitable electromechanical device or devices for determining a force applied by cutting member 305 to an object having known properties (e.g., object 308). For example, testing assembly 315 may include a force transducer. For example, testing assembly 315 may include a force transducer that may measure an amount of force (e.g., using any suitable units such as grams) used by cutting edge portion 330 to cut an object of known properties (e.g., object 308 that may be a standard test object or test strip). Testing assembly 315 may thereby measure properties indicative of a sharpness of cutting member 305 (e.g., of cutting edge portion 330). In at least some exemplary embodiments, testing assembly 315 may utilize the Brubacher Edge Sharpness Scale (BESS) or any other suitable standard or system for accurately and precisely measuring properties indicative of a sharpness of cutting member 305. For example, system 300 may determine a sharpness of cutting edge portion 330 as a value between 0 and 2000 using the BESS scale. For example, a BESS result associated with an amount of force (e.g., cutting force) of between about 400 grams and about 1000 grams (for example, 600 grams or any other suitable value) may be measured using the BESS scale for a sharpness of cutting edge portion 330. Testing assembly 315 may include any suitable communication components for transferring data to and communicating with network 320, user device 325, and/or any other suitable component of system 300 for example via the exemplary disclosed communication techniques described herein. The exemplary disclosed controller and module may process and perform calculations using the sensed data to determine any suitable properties of cutting member 305 such as, for example, a sharpness of cutting edge portion 330 of cutting member 305 (e.g., or these properties may be directly determined by testing assembly 315 and provided to the exemplary disclosed controller and module as sensed data).

In at least some exemplary embodiments, cutting edge portion 330 may have a sharpness (e.g., measured using the BESS scale or any other suitable measuring technique and an associated amount of force) that may be less than a sharpness (e.g., and an associated amount of force) for cutting human skin. For example, cutting edge portion 330 may have a sharpness measured using the BESS scale of between about 400 and about 1000 (e.g., greater than 400 or 500) that may not cut human skin when applied against human skin with between about 400 grams and about 1000 grams of force (e.g., when cutting edge portion 330 is formed from ceramic material or any other suitable material). Cutting edge portion 330 may thereby have a sharpness and associated application force value (e.g., between about 400 grams and about 1000 grams of force) that may be less than a cut resistance of human skin (e.g., when cutting edge portion 330 is formed from ceramic material or any other suitable material).

The exemplary disclosed system and method may be used in any suitable application for providing a cutting member. For example, the exemplary disclosed system and method may be used in any suitable application for manufacturing of a blade. The exemplary disclosed system and method may be used in any suitable application involving quality control during manufacture of a blade. The exemplary disclosed system and method may also be used in any suitable application for measuring and controlling a sharpness of a blade.

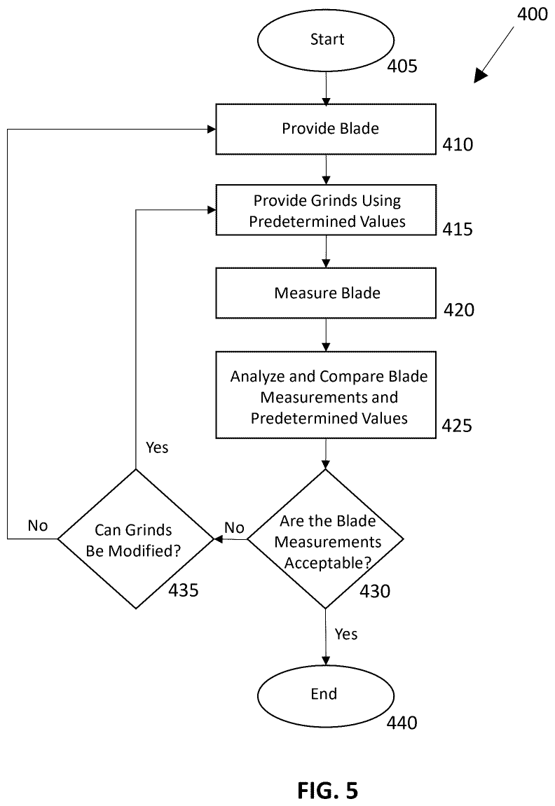

FIG. 5 illustrates an exemplary operation or algorithm of exemplary disclosed system 300. Process 400 begins at step 405. At step 410, cutting member 305 is provided. In at least some exemplary embodiments at step 410, cutting member 305 may be a blank such as a blade blank. Cutting member 305 may be provided having thickness T.

At step 415, the primary grind of primary edge portion PD and the micro grind of micro edge portion MD may be provided using any suitable manufacturing technique such as, for example, grinding such as belt grinding, jig grinding, or wheel grinding, machining such as high-speed machining, and/or any other suitable technique for providing a grind.

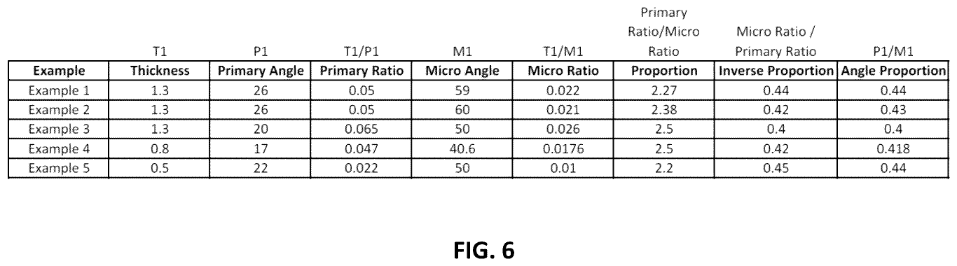

The grind of primary edge 340 of primary edge portion PD may be provided at primary angle P. The grind of primary edge 340 may be provided based on a predetermined primary ratio. FIG. 6 illustrates exemplary predetermined primary ratios. The predetermined primary ratio may be a predetermined thickness (e.g., T1 as set forth in FIG. 6) divided by a predetermined primary angle (e.g., P1 as set forth in FIG. 6). As set forth in the examples in FIG. 6, the predetermined primary ratio may be expressed as T1/P1. The predetermined primary ratio may be based on T1 and P1 being expressed in any suitable units such as, for example, T1 being expressed in any suitable unit of length (e.g., inches or metric distance such as millimeters) and P1 being expressed in degrees (e.g., or radians). Any suitable number of predetermined primary angles based on respective predetermined thicknesses T1 and predetermined primary angles P1 (e.g., that may for example correspond to blade types, blade products for example based on stock-keeping unit number or other suitable organizational references, or any other type or organizational category) may be stored as data (e.g., data values) by the exemplary disclosed module (e.g., using memory for example as disclosed in FIG. 7). For example as set forth in FIG. 6, a given predetermined primary angle P1 and predetermined thickness T1 may correspond to a given example, product, type, application, or category (e.g., examples 1 through 5). The exemplary disclosed module may also store data of a predetermined primary angle range including a given predetermined primary angle. For example, a predetermined primary angle range may be a data range centered on a given predetermined primary angle based on a desired tolerance (e.g., blade measurement tolerance such as standard tolerance ranges for ceramic blade manufacturing), standard deviation, and/or any other desired range including the predetermined primary angle. The exemplary disclosed module may similarly store data of a predetermined thickness range including the predetermined thickness.

The grind of primary edge 340 of primary edge portion PD may be provided at primary angle P based on the predetermined primary ratio. For example, primary edge 340 may be provided at primary angle P based on using the relationship of the predetermined primary ratio=T1/P1, where a given predetermined primary ratio may be obtained by the exemplary disclosed module (e.g., based on a given example, product, type, application, or category of blade to be provided). T1 may be similarly obtained from the exemplary disclosed module. T1 may also be known for a given cutting member 305 (e.g., for a given type of blade blank). For example when T1 is known for a given cutting member 305 and the given predetermined primary ratio is obtained by the exemplary disclosed module, system 300 may determine primary angle P to be provided as set or equal to predetermined primary angle P1, with P1=T1/(predetermined primary ratio).

For example using the exemplary disclosed module and API for example with user device 325, a user may enter input indicative of a given example, product, type, application, or category of blade and/or of a type of blade blank. System 300 (e.g., the exemplary disclosed controller and module) may then operate to determine primary angle P is to be provided as equal or set to predetermined primary angle P1 as determined above. Any of predetermined thickness T1, predetermined primary angle P1, and/or the predetermined primary ratio may be determined based on user input, data provided by sensing assembly 310, and/or data retrieved from a bar code scanner or other suitable device, with system 300 operating to determine primary angle P (e.g., as equal to predetermined primary angle P1) or thickness T (e.g., set as predetermined thickness T1) to be provided for example based on the exemplary relationships described above and for example as illustrated in FIG. 6.

The grind of micro edge 335 of micro edge portion MD may be provided at micro angle M. The grind of micro edge 335 may be provided based on a predetermined micro ratio. FIG. 6 illustrates exemplary predetermined micro ratios. The predetermined micro ratio may be a predetermined thickness (e.g., T1 as set forth in FIG. 6) divided by a predetermined micro angle (e.g., M1 as set forth in FIG. 6). As set forth in the examples in FIG. 6, the predetermined micro ratio may be expressed as T1/M1. The predetermined micro ratio may be based on T1 and M1 being expressed in any suitable units such as, for example, T1 being expressed in any suitable unit of length (e.g., inches or metric distance such as millimeters) and M1 being expressed in degrees (e.g., or radians). Any suitable number of predetermined micro angles based on respective predetermined thicknesses T1 and predetermined micro angles M1 (e.g., that may for example correspond to blade types, blade products for example based on stock-keeping unit number or other suitable organizational references, or any other type or organizational category) may be stored as data (e.g., data values) by the exemplary disclosed module (e.g., using memory for example as disclosed in FIG. 7). For example as set forth in FIG. 6, a given predetermined micro angle M1 and predetermined thickness T1 may correspond to a given example, product, type, application, or category (e.g., examples 1 through 5). The exemplary disclosed module may also store data of a predetermined micro angle range including a given predetermined micro angle. For example, a predetermined micro angle range may be a data range centered on a given predetermined micro angle based on a desired tolerance (e.g., blade measurement tolerance such as standard tolerance ranges for ceramic blade manufacturing), standard deviation, and/or any other desired range including the predetermined micro angle. The exemplary disclosed module may similarly store data of a predetermined thickness range including the predetermined thickness.

The grind of micro edge 335 of micro edge portion MD may be provided at micro angle M based on the predetermined micro ratio. For example, micro edge 335 may be provided at micro angle M based on using the relationship of the predetermined micro ratio=T1/M1, where a given predetermined micro ratio may be obtained by the exemplary disclosed module (e.g., based on a given example, product, type, application, or category of blade to be provided). T1 may be similarly obtained from the exemplary disclosed module. T1 may also be known for a given cutting member 305 (e.g., for a given type of blade blank). For example when T1 is known for a given cutting member 305 and the given predetermined micro ratio is obtained by the exemplary disclosed module, system 300 may determine micro angle M to be provided as set or equal to predetermined micro angle M1, with M1=T1/(predetermined micro ratio). For example using the exemplary disclosed module and API for example with user device 325, a user may enter input indicative of a given example, product, type, application, or category of blade and/or of a type of blade blank. System 300 (e.g., the exemplary disclosed controller and module) may then operate to determine micro angle M is to be provided as equal or set to predetermined micro angle M1 as determined above. Any of predetermined thickness T1, predetermined micro angle M1, and/or the predetermined micro ratio may be determined based on user input, data provided by sensing assembly 310, and/or data retrieved from a bar code scanner or other suitable device, with system 300 operating to determine micro angle M (e.g., as equal to predetermined micro angle M1) or thickness T (e.g., set as predetermined thickness T1) to be provided for example based on the exemplary relationships described above and for example as illustrated in FIG. 6.

FIG. 6 sets forth examples of additional exemplary relationships that may be used by system 300 (e.g., the exemplary disclosed controller and module) to determine any of thickness T (e.g., to be set equal to predetermined thickness T1), primary angle P (e.g., to be set equal to predetermined primary angle P1), micro angle M (e.g., to be set equal to predetermined micro angle M1), a given predetermined primary ratio, and/or a given predetermined micro ratio. For example, the exemplary disclosed controller and module may store and utilize data indicative of a predetermined proportion (e.g., predetermined primary ratio/predetermined micro ratio), a predetermined inverse proportion (e.g., predetermined micro ratio/predetermined primary ratio), and/or a predetermined angle proportion (e.g., predetermined primary angle P1/predetermined micro angle M1) to determine any of predetermined primary angle P1, predetermined micro angle M1, predetermined thickness T1, a given predetermined primary ratio, and/or a given predetermined micro ratio similarly to for example as described above. For example, the exemplary disclosed controller and module may utilize the exemplary disclosed input and criteria providing some of the exemplary disclosed values to determine other of the exemplary disclosed values using the exemplary disclosed relationships described above (e.g., and as set forth in the examples of FIG. 6). The exemplary disclosed controller and module may also store and utilize data indicative of a predetermined sharpness of cutting edge portion 330 (e.g., data values of the BESS scale or any other data values for measuring sharpness). For example, a plurality of predetermined sharpness values that correspond to a plurality of corresponding predetermined primary ratio values and/or predetermined micro ratio values may be stored and utilized by system 300 (e.g., the exemplary disclosed controller and module). For example based on empirical testing data, processing and calculations, and/or user input provided for example by techniques as described herein, the exemplary disclosed controller and module may determine, store, and/or utilize a plurality of predetermined sharpness values associated with corresponding measured and/or determined sharpnesses of blades having corresponding predetermined primary ratio values and predetermined micro ratio values.

At step 420, system 300 may measure cutting member 305. For example, sensing assembly 310 may operate to measure properties indicative of primary angle P, micro angle M, and/or thickness T of cutting member 305. Testing assembly 315 may operate to measure properties indicative of a sharpness of cutting edge portion 330 (e.g., as a value between 0 and 2000 using the BESS scale). Sensing assembly 310 and/or testing assembly 315 may transfer data indicative of primary angle P, micro angle M, and/or thickness T of cutting member 305 and/or a sharpness of cutting edge portion 330 to the exemplary disclosed controller and module (e.g., network 320 and/or to user device 325) via any suitable communication techniques for example as described herein.

At step 425, the exemplary disclosed controller and module may process and perform calculations using the sensed data transferred at step 420, stored predetermined data values for example as described herein (e.g., predetermined thicknesses T1, predetermined primary angles P1, and/or predetermined micro angles M1 for example as described herein), exemplary disclosed relationships (e.g., one or more predetermined primary ratios, predetermined micro ratios, predetermined proportions, predetermined inverse proportions, and/or predetermined angle proportions), and/or any other suitable algorithms and/or predetermined criteria for example as described herein. For example, system 300 (e.g., the exemplary disclosed controller and module) may analyze and compare measurements of cutting member 305 (e.g., thickness T, primary angle P, micro angle M, and/or the measured sharpness of cutting edge portion 330 using testing assembly 315) with corresponding predetermined values (e.g., predetermined thickness T1, predetermined primary angle P1, predetermined micro angle M1, and/or predetermined sharpness values). The exemplary disclosed controller and module may also perform calculations based on the exemplary disclosed predetermined values and relationships described herein (e.g., described at step 415). In at least some exemplary embodiments, the exemplary disclosed controller and module may analyze the measurements made and transferred at step 420 using the exemplary disclosed proportional relationships and based on differences in thickness T of various cutting members 305.

At step 430, system 300 (e.g., the exemplary disclosed controller and module) may determine whether or not the measurement data of cutting member 305 sensed at step 420 (e.g., thickness T, primary angle P, micro angle M, and/or the measured sharpness of cutting edge portion 330) are substantially equal to, about equal to, or fall within a predetermined range of the corresponding predetermined values (e.g., predetermined thickness T1, predetermined primary angle P1, predetermined micro angle M1, and/or predetermined sharpness values). If system 300 (e.g., the exemplary disclosed controller and module) determines that measurement data of cutting member 305 sensed at step 420 are substantially equal to, about equal to, or fall within a predetermined range of the corresponding predetermined values (e.g., thickness T is substantially equal to, about equal to, or falls within a predetermined range of predetermined thickness T1; primary angle P is substantially equal to, about equal to, or falls within a predetermined range of predetermined primary angle P1; and/or micro angle M is substantially equal to, about equal to, or falls within a predetermined range of predetermined micro angle M1), then cutting member 305 is determined as having suitable quality, sharpness, safety, and/or cutting characteristics, and process 400 ends at step 440.

If system 300 (e.g., the exemplary disclosed controller and module) determines at step 430 that measurement data of cutting member 305 sensed at step 420 are not substantially equal to, about equal to, or fall within a predetermined range of the corresponding predetermined values (e.g., thickness T is not substantially equal to, not about equal to, or does not fall within a predetermined range of predetermined thickness T1; primary angle P is not substantially equal to, not about equal to, or does not fall within a predetermined range of predetermined primary angle P1; and/or micro angle M is not substantially equal to, not about equal to, or does not fall within a predetermined range of predetermined micro angle M1), then cutting member 305 is determined as not having suitable quality, sharpness, safety, and/or cutting characteristics, and system 300 proceeds to step 435.

At step 435, system 300 (e.g., the exemplary disclosed controller and module) may determine whether the grind of primary edge 340 of primary edge portion PD and/or the grind of micro edge 335 of micro edge portion MD may be modified (e.g., whether further grinding may be performed) based on user input for example via network 320 and/or user device 325, a blade type or category, and/or any other suitable predetermined criteria. If the grinds may be modified, system 300 may return to step 415 to provide further grinds. If the grinds may not be modified, system 300 returns to step 410 to provide a new cutting member 305. The exemplary disclosed steps of process 400 may be iteratively repeated as desired until measurements are determined as acceptable at step 430 and process 400 then ends at step 440.

In at least some exemplary embodiments, the exemplary disclosed system and method may provide a method for blade sharpness control such as, for example, ceramic blade sharpness control. In at least some exemplary embodiments, the exemplary disclosed system and method may utilize a fixed sharpened profile in which cutting edge portion 330 may not be resharpened during a life of cutting member 305.

In at least some exemplary embodiments, the exemplary disclosed system and method may utilize a novel approach to a useful life cycle of a cutting tool's sharpened edge. For example, the exemplary disclosed system and method may utilize a substantially fixed sharpening profile (e.g., a fixed sharpening profile), as opposed to maximizing a sharpness of a blade edge for the purpose of extending or maximizing a time between sharpening cycles. In at least some exemplary embodiments, cutting edge portion 330 may not be resharpened during a normal life of the blade. When for example a sharper edge may become appropriate due to wear, a given cutting member 305 may be replaced with a new cutting member 305.

In at least some exemplary embodiments, cutting edge portion 330 (e.g., a blade edge of a ceramic blade) may be intentionally reduced in sharpness compared to a metal blade edge (e.g., a sharpened metal blade edge). This intentional reduction in sharpness may provide both adequate cutting performance of cutting member 305 while also improving (e.g., significantly improving) a safety of the exposed cutting edge (e.g., cutting edge portion 330). For example in at least some exemplary embodiments, because ceramic may be many times harder than metal, a sharpness of cutting edge portion 330 formed from ceramic material may be reduced (e.g., relative to metal material that may be less hard) to a level that may still perform a variety of cutting tasks in an efficient and effective manner and for a greater (e.g., significantly greater) time or use cycle compared to blades formed from metal material. Additionally, the reduced sharpness of cutting edge portion 330 formed from ceramic material may provide an edge that may reduce (e.g., significantly reduce) a risk to a user of laceration, puncture, and/or other cutting hazards associated with metal blades. The exemplary disclosed system and method may thereby, in at least some exemplary embodiments, provide a cutting edge having a combination of sharpness features and hardness features for the purpose of providing both safety for users and also longevity of a service life of a blade.

In at least some exemplary embodiments, a blade edge of a ceramic blade (e.g., cutting edge portion 330) may be intentionally reduced in sharpness for the purpose of providing both adequate cutting performance and significantly improving a safety of the exposed cutting edge. Because ceramic may be relatively hard (e.g., many times harder than metal), a sharpness of cutting member 305 that may be formed from ceramic may be reduced to a level of sharpness that may still perform a variety of cutting tasks in a very efficient and effective manner for a relatively long service life. At the same time, the reduced sharpness of cutting member 305 may provide an edge (e.g., cutting edge portion 330) that may significantly reduce a risk of laceration, puncture, and other cutting hazards (e.g., associated with metal blades).

In at least some exemplary embodiments, the exemplary disclosed system and method may provide a combination of blade thickness, primary grind, and micro grind that may allow cutting member 305 (e.g., a blade) to cut within a defined efficiency while at the same time providing a controlled, reduced sharpness, which may provide a relatively safer alternative to ultra-sharp metal edges.

In at least some exemplary embodiments, the exemplary disclosed system and method may provide a technique for quantifying a desired performance of the exemplary disclosed combination of blade thickness, primary grind, and micro grind, which may be readily and reliably employed in a manufacturing environment. The exemplary disclosed system and method may provide a methodology for quantifying and ensuring a consistent quality level of sharpness and safety for a large variety of blades, blade types, blade profiles, applications, and uses.

In at least some exemplary embodiments, the exemplary disclosed system and method may provide a cutting member (e.g., cutting member 305) that may minimize lacerations, punctures, and other cutting tool injury hazards. The exemplary disclosed system and method may utilize the hardness of ceramic to produce a blade profile that is effective for cutting while also reducing sharpness to a level that significantly reduces a possibility of lacerations, punctures and other injuries due to cutting accidents.

In at least some exemplary embodiments, the exemplary disclosed system and method may provide a cutting member (e.g., cutting member 305) having a micro grind including a relatively large angle and/or a faceted surface along a cutting edge (e.g., cutting edge portion 330). The exemplary disclosed system and method may provide a ceramic cutting member (e.g., cutting member 305) having a relatively thick cross-section and including a combination of primary and micro grind angle profiles having a relatively less acute edge profile than metal blade profiles. The exemplary disclosed system and method may provide a cutting member (e.g., cutting member 305) having a combination of a functional primary grind and a micro grind facet that may distribute forces along the edge such that lacerating of the skin involves a relatively greater force than metal blades to produce the same result. The exemplary disclosed system and method may thereby provide a cutting member (e.g., cutting member 305) having a blade profile that may be efficient for the majority of cutting tasks while also providing a relatively safe blade profile.

In at least some exemplary embodiments, the exemplary disclosed system and method may define parameters for establishing a relationship between a blade thickness, a primary grind angle, and a micro grind angle. The exemplary disclosed system and method may provide a technique for quantifying grind profiles of various blade types that satisfy a consistent, standardized performance and safety metric or set of safety metrics. The exemplary disclosed system and method may provide metrics such that in-process measurements may be readily performed during the production of the blades without involving specialized equipment and/or training to complete.

In at least some exemplary embodiments, the exemplary disclosed system and method may provide metrics for repeatable, accurate, and precise dimensions for cutting members manufactured in mass production (e.g., including standard tolerance ranges for ceramic blade manufacturing). The exemplary disclosed system and method may be used (e.g., in periodic measurements on a lot percentage basis) to attempt to ensure consistency and quality in mass production.

In at least some exemplary embodiments, the exemplary disclosed method may include providing a ceramic blade having a thickness and a ceramic cutting edge portion (e.g., cutting edge portion 330), providing a primary grind having a primary angle to the ceramic cutting edge portion based on a predetermined primary ratio, and providing a micro grind having a micro angle to the ceramic cutting edge portion based on a predetermined micro ratio. The predetermined primary ratio may be a predetermined thickness divided by a predetermined primary angle. The predetermined micro ratio may be the predetermined thickness divided by a predetermined micro angle. The exemplary disclosed method may also include measuring at least one of the thickness, the primary angle, and the micro angle, and comparing at least one of the measured thickness to the predetermined thickness, the measured primary angle to the predetermined primary angle, and the measured micro angle to the predetermined micro angle. The exemplary disclosed method may further include measuring all of the thickness, the primary angle, and the micro angle, and comparing all of the measured thickness to the predetermined thickness, the measured primary angle to the predetermined primary angle, and the measured micro angle to the predetermined micro angle. The exemplary disclosed method may also include measuring a sharpness of the ceramic cutting edge portion and comparing the sharpness of the ceramic cutting edge portion to a predetermined sharpness that is based on the predetermined primary ratio and the predetermined micro ratio. Measuring the sharpness of the ceramic cutting edge portion may include measuring an amount of force used by the ceramic cutting edge portion in cutting an object of known properties. The predetermined primary ratio may be between 0.02 and 0.07 with the predetermined thickness having a unit of millimeters and the predetermined primary angle having a unit of degrees. The predetermined micro ratio may be between 0.01 and 0.03 with the predetermined thickness having a unit of millimeters and the predetermined micro angle having a unit of degrees. One of the predetermined thickness and the predetermined primary angle may be determined based on a predetermined proportion that is the predetermined primary ratio divided by the predetermined micro ratio. One of the predetermined thickness and the predetermined micro angle may be determined based on a predetermined inverse proportion that is the predetermined micro ratio divided by the predetermined primary ratio. Measuring the at least one of the thickness, the primary angle, and the micro angle may include using an optical comparator.

In at least some exemplary embodiments, the exemplary disclosed method may include providing a ceramic blade having a thickness and a ceramic cutting edge portion (e.g., cutting edge portion 330), providing a primary grind having a primary angle to the ceramic cutting edge portion based on a predetermined primary ratio, and providing a micro grind having a micro angle to the ceramic cutting edge portion based on a predetermined micro ratio. The predetermined primary ratio may be a predetermined thickness divided by a predetermined primary angle. The predetermined micro ratio may be the predetermined thickness divided by a predetermined micro angle. The exemplary disclosed method may also include measuring a sharpness of the ceramic cutting edge portion and comparing the sharpness of the ceramic cutting edge portion to a predetermined sharpness that is based on the predetermined primary ratio and the predetermined micro ratio. The exemplary disclosed method may further include measuring at least one of the thickness, the primary angle, and the micro angle, and comparing at least one of the measured thickness to the predetermined thickness, the measured primary angle to the predetermined primary angle, and the measured micro angle to the predetermined micro angle. The exemplary disclosed method may also include measuring all of the thickness, the primary angle, and the micro angle, and comparing all of the measured thickness to the predetermined thickness, the measured primary angle to the predetermined primary angle, and the measured micro angle to the predetermined micro angle. Measuring all of the thickness, the primary angle, and the micro angle may include using an optical comparator. Measuring the sharpness of the ceramic cutting edge portion may include measuring an amount of force used by the ceramic cutting edge portion in cutting an object of known properties. Measuring the amount of force used by the ceramic cutting edge portion may include using a force transducer. The object of known properties may be a test strip.

In at least some exemplary embodiments, the exemplary disclosed method may include providing a ceramic blade having a thickness and a ceramic cutting edge portion, providing a primary grind having a primary angle to the ceramic cutting edge portion (e.g., cutting edge portion 330) based on a predetermined primary ratio, and providing a micro grind having a micro angle to the ceramic cutting edge portion based on a predetermined micro ratio. The predetermined primary ratio may be a predetermined thickness divided by a predetermined primary angle. The predetermined micro ratio may be the predetermined thickness divided by a predetermined micro angle. The exemplary disclosed method may also include measuring the primary angle and comparing the measured primary angle to a predetermined primary angle range including the predetermined primary angle, measuring the micro angle and comparing the measured micro angle to a predetermined micro angle range including the predetermined micro angle, and measuring the thickness and comparing the measured thickness to a predetermined thickness range including the predetermined thickness. The exemplary disclosed method may further include measuring a sharpness of the ceramic cutting edge portion and comparing the measured sharpness of the ceramic cutting edge portion to a predetermined sharpness range that is based on the predetermined primary ratio and the predetermined micro ratio. The predetermined primary ratio may be between 0.047 and 0.065 with the predetermined thickness having a unit of millimeters and the predetermined primary angle having a unit of degrees. The predetermined micro ratio may be between 0.017 and 0.026 with the predetermined thickness having a unit of millimeters and the predetermined micro angle having a unit of degrees.

In at least some exemplary embodiments, a desired value or range of values may be determined, produced, measured, and compared using the exemplary disclosed system and method to produce a desired result. The exemplary disclosed system and method may provide an efficient and effective technique for providing a cutting member that is both suitable for cutting and safe for users to handle. The exemplary disclosed system and method may provide a blade having reduced sharpness that improves a safety of the blade while also providing suitable cutting properties based on a hardness of the blade. The exemplary disclosed system and method may also provide a cutting member that does not involve sharpening during its use over an extended period of time.

An illustrative representation of a computing device appropriate for use with embodiments of the system of the present disclosure is shown in FIG. 7. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 8, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 8, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 8, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system may for example utilize collected data to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary disclosed system may utilize neural network-based artificial intelligence to predictively assess risk. For example, the exemplary neural network may include a plurality of input nodes that may be interconnected and/or networked with a plurality of additional and/or other processing nodes to determine a predicted result (e.g., a location as described for example herein).

For example, exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to make predictions based on data collected by the exemplary disclosed sensors.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation Kotlin, Swift, C#, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on-any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A method, comprising:
providing a ceramic blade having a thickness and a ceramic cutting edge portion;
providing a primary grind having a primary angle to the ceramic cutting edge portion based on a predetermined primary ratio;
providing a micro grind having a micro angle to the ceramic cutting edge portion based on a predetermined micro ratio;
wherein the predetermined primary ratio is a predetermined thickness divided by a predetermined primary angle;
wherein the predetermined micro ratio is the predetermined thickness divided by a predetermined micro angle;
measuring at least one of the thickness, the primary angle, and the micro angle; and
comparing at least one of the measured thickness to the predetermined thickness, the measured primary angle to the predetermined primary angle, and the measured micro angle to the predetermined micro angle.

2. The method of claim 1, further comprising:
measuring all of the thickness, the primary angle, and the micro angle; and
comparing all of the measured thickness to the predetermined thickness, the measured primary angle to the predetermined primary angle, and the measured micro angle to the predetermined micro angle.

3. The method of claim 1, further comprising measuring a sharpness of the ceramic cutting edge portion and comparing the sharpness of the ceramic cutting edge portion to a predetermined sharpness that is based on the predetermined primary ratio and the predetermined micro ratio.

4. The method of claim 3, wherein measuring the sharpness of the ceramic cutting edge portion includes measuring an amount of force used by the ceramic cutting edge portion in cutting an object of known properties.

5. The method of claim 3, wherein the sharpness of the ceramic cutting edge portion is less than a sharpness for exceeding a cut resistance of human skin when the ceramic cutting edge portion is applied against human skin.

6. The method of claim 5, wherein the ceramic cutting edge portion is applied against human skin using between 400 grams and 1000 grams of force.

7. The method of claim 1, wherein the predetermined primary ratio is between 0.02 and 0.07 with the predetermined thickness having a unit of millimeters and the predetermined primary angle having a unit of degrees.

8. The method of claim 1, wherein the predetermined micro ratio is between 0.01 and 0.03 with the predetermined thickness having a unit of millimeters and the predetermined micro angle having a unit of degrees.

9. The method of claim 1, wherein one of the predetermined thickness and the predetermined primary angle is determined based on a predetermined proportion that is the predetermined primary ratio divided by the predetermined micro ratio.

10. The method of claim 1, wherein one of the predetermined thickness and the predetermined micro angle is determined based on a predetermined inverse proportion that is the predetermined micro ratio divided by the predetermined primary ratio.
